(19) United States
(12) Patent Application Publication
(10) Pub. No.: US 2021/0322852 A1
(43) Pub. Date: Oct. 21, 2021

(54) DETERMINING TRAJECTORY OF A BALL FROM TWO-DIMENSIONAL MEDIA-CONTENT USING COMPUTER VISION

(71) Applicant: Stupa Sports Analytics Private Limited, New Delhi (IN)

(72) Inventors: Megha Gambhir, New Delhi (IN); Deepak Malik, New Delhi (IN)

(73) Assignee: Stupa Sports Analytics Private Limited, New Delhi (IN)

(21) Appl. No.: 17/229,101

(22) Filed: Apr. 13, 2021

(30) Foreign Application Priority Data
Apr. 21, 2020 (IN) 202011017127

(51) Int. Cl. A63B 71/06; G06T 7/194; G06K 9/46; G06T 7/215; G06K 9/62; G06K 9/00; G06T 7/11; A63B 24/00

(52) U.S. Cl. CPC A63B 71/0622; A63B 2102/16; G06K 9/4604; G06T 7/215; G06K 9/6256; G06K 9/00288; G06T 7/11; A63B 24/0021; G06T 2207/30224; G06T 2207/30241; G06T 2207/20084; A63B 2024/0034; A63B 2220/05; A63B 2220/807; A63B 2071/0647; G06T 7/194

(57) ABSTRACT

A method of determining a trajectory of a ball from a two-dimensional (2D) media-content using computer vision is provided. The method includes localizing a foreground TT game in the 2D media-content using facial recognition of players associated with the foreground TT game, obtaining a background subtracted media-content that identifies moving objects in the foreground TT game, locating edges of a TT table associated with the foreground TT game using computer vision, determining a pixel-to-metric unit ratio between the 2D media-content and the TT table by superimposing the edges with dimensions of the TT table, identifying a contour information of the trajectory of the ball after the ball is serviced using computer vision methods, determining a speed of the ball in the trajectory using the pixel-to-metric unit ratio and the contour information, transforming the speed into a three-dimensional speed and, determining the trajectory of the ball in the global area.

### BACKGROUND

### Cross-Reference to Related Applications

This patent application claims priority to Indian provisional patent application no: 202011017127 filed on Apr. 21, 2020, the complete disclosure of which, in its entirety, is hereby incorporated by reference.

### Technical Field

The embodiments herein relate to devices and systems for trajectory analysis, and more specifically to determine a trajectory of a ball.

### Description of the Related Art

Analytics of table tennis matches is still nascent field and performance analytics has hitherto been limited to simple metrics such as count of shots played in a rally and simple ball placement heatmaps. Analytics based on such simple metrics have been done primarily through manual methods of annotation. Further, for players that enjoy games or motivated by competition, there are no simple, non-intrusive, cost-effective ways to track their game without using any special equipment and in a normal table tennis environment. The traditional approaches of ball-tracking in vogue rely on deep learning-based object localization. These approaches build on large deep neural network backbones and train them to specifically track a table tennis ball. This approach, however, requires that the ball be clearly visible and more particularly, the object in a frame should not have any distortion. This in turn requires recording the videos in a high resolution as well as high frequency (i.e., frames per second). Also, such approaches are computationally intensive and require Graphics Processing Units (GPU).

The traditional approaches are difficult to implement when there are multiple moving objects in the background and if any noise exists due to people's movement due to other matches happening in the background such as in a local tournament or a coaching center. Another drawback of the traditional approaches is that they are developed for generic fast-moving object tracking. Various parameters such as pixel-to-centimeters and expected shape of the fast-moving object need to be fed into the system. This makes it practically unusable in real-life table tennis match scenarios.

Accordingly, there remains a need to address the aforementioned technical drawbacks using a system and method for determining a trajectory of a ball.

### SUMMARY

In view of the foregoing, an embodiment herein provides a method of determining a trajectory of a ball from a two-dimensional (2D) media-content using computer vision. The method includes one or more of (a) eliminating background of a 2D media-content of a global area that is captured from an image capturing device to obtain a background subtracted media-content that identifies moving objects in a foreground TT game, (b) locating one or more edges of a TT table associated with the foreground TT game from the background subtracted media-content using computer vision methods that automatically extract and analyze useful information from a single image or a sequence of images associated with the 2D media-content, (c) determining a pixel-to-metric unit ratio between the 2D media-content and the TT table by superimposing the one or more edges with dimensions of the TT table, (d) identifying a contour information of the trajectory of the ball after the ball is serviced using computer vision methods, the contour information includes a contour length, a thickness, end points and a centroid of the trajectory, (e) determining a speed of the ball in the trajectory using the pixel-to-metric unit ratio and the contour information, (f) transforming the speed that is based on the 2D media-content into a three-dimensional speed, and (g) determining the trajectory of the ball in the global area using spline interpolation based on the contour information and the three-dimensional speed of the ball.

In some embodiments, a linear or polynomial regression model may be used for transforming the speed of the ball into the three-dimensional speed.

In some embodiments, the method includes localizing the ball immediately after the ball is serviced by performing a global search in the 2D media-content for a colored streak of an expected dimension and locating a region closer to a player associated with servicing the ball.

In some embodiments, the method includes identifying the contour information is optimized by (a) determining an expected trajectory of the ball using spline extrapolation based on the contour information and the three-dimensional speed of the ball, and (b) obtaining a region of interest (ROI) in the 2D media content based on the expected trajectory to localize the global search, dimensions of the region of interest are based on the three-dimensional speed of the ball.

In some embodiments, the method obtains a look ahead ROI and the look behind ROI that vary based on the three-dimensional speed and a direction of the ball. In some embodiments, the method includes (a) processing the one or more frames obtained from an image search of the global area in a dense layer neural network to obtain a learned image transformation, and (b) classifying a shot-type executed by the player by processing the learned image transformations using a recurrent neural network.

In some embodiments, a heatmap of pitch locations is generated to visually analyze the foreground TT game, the heatmap includes the three-dimensional speed of the ball, a placement of the ball into one or more zones in the TT table, and an indicator that classifies that the placement resulted in a point win or a point loss.

In some embodiments, the method includes generating a top-down view of the pitch locations on a TT table by (a) interpolating the one or more coordinates of the 2D media-content, and (b) generating the top-down view using a perspective transformation.

In some embodiments, the top-down view is combined with the shot-type and the three-dimensional ball speed to enable placement analytics of the player.

In some embodiments, actions of the player in the foreground TT game are classified using a deep learning model that is based on face recognition and human pose models.

In some embodiments, the foreground TT game is localized in the 2D media-content using facial recognition of one or more players associated with the foreground TT game.

In another aspect, there is provided a system for determining a trajectory of a ball from a two-dimensional (2D) media content using computer vision. The system includes an image capturing device that captures the 2D media content of at least one TT table in a global area, and a trajectory tracking system that analyzes one or more frames of the 2D media content associated with said at least one TT table in the global area and determines a trajectory of the ball, the trajectory tracking system is communicatively connected to the image capturing device. The trajectory tracking system includes (i) a memory that stores a database and a set of modules, (ii) a device processor that executes said set of modules, where said set of modules include (a) a background elimination module that eliminates background of the 2D media-content to obtain a background subtracted media-content that identifies moving objects in a foreground TT game, (b) a pixel-to-metric determination module that locates one or more edges of a TT table associated with the foreground TT game from the background subtracted media-content using computer vision methods that automatically extract and analyze useful information from a single image or a sequence of images associated with the 2D media-content and determines a pixel-to-metric unit ratio between the 2D media-content and the TT table by superimposing the one or more edges with dimensions of the TT table, (c) a contour information module that identifies a contour information of the trajectory of the ball after the ball is serviced using computer vision methods, the contour information includes a contour length, a thickness, end points and a centroid of the trajectory, (d) a speed determination module that determines a speed of the ball in the trajectory using the pixel-to-metric unit ratio and the contour information, and transforms the speed that is based on the 2D media-content into a three-dimensional speed, and (e) a trajectory determination module that determines the trajectory of the ball in the global area using spline interpolation based on the contour information and the three-dimensional speed of the ball.

In another aspect, there is provided one or more non-transitory computer-readable storage medium storing the one or more sequence of instructions, which when executed by a processor, to perform a method of determining a trajectory of a ball from a two-dimensional (2D) media-content using computer vision, the method includes (a) eliminating background of a 2D media-content of a global area that is captured from an image capturing device to obtain a background subtracted media-content that identifies moving objects in a foreground TT game, (b) locating one or more edges of a TT table associated with the foreground TT game from the background subtracted media-content using computer vision methods that automatically extract and analyze useful information from a single image or a sequence of images associated with the 2D media-content, (c) determining a pixel-to-metric unit ratio between the 2D media-content and the TT table by superimposing the one or more edges with dimensions of the TT table, (d) identifying a contour information of the trajectory of the ball after the ball is serviced using computer vision methods, the contour information includes a contour length, a thickness, end points and a centroid of the trajectory, (e) determining a speed of the ball in the trajectory using the pixel-to-metric unit ratio and the contour information, (f) transforming the speed that is based on the 2D media-content into a three-dimensional speed, and (g) determining the trajectory of the ball in the global area using spline interpolation based on the contour information and the three-dimensional speed of the ball.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram of a system for determining a trajectory of a ball according to some embodiments herein;

FIG. 2 is an exploded view of a trajectory tracking server of FIG. 1 according to some embodiments herein;

FIG. 3 is a block diagram for classifying a shot-type executed by a player in a foreground TT game according to some embodiments herein;

FIG. 4 is an exemplary view of a table of rallies that end at a fourth contact for a player according to some embodiments herein;

FIG. 5 is a block diagram of placement analytics of the one or more players associated with the foreground TT game according to some embodiments herein;

FIG. 6 is an exemplary view of one or more zones in the TT table that are used to generate the heatmap of pitch locations according to some embodiments herein;

FIG. 7 is an exemplary view of a first top-down view of the pitch locations of the foreground TT game on the TT table for enabling placement analytics of the one or more players according to some embodiments herein;

FIG. 8 is an exemplary view of a second top-down view generated based on the trajectory of a rally of the ball of according to some embodiments herein;

FIGS. 9A and 9B are flow diagrams of a method for determining a trajectory of a ball from the 2D media-content using computer vision according to some embodiments herein; and

FIG. 10 is a block diagram of a device used in accordance with embodiments herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

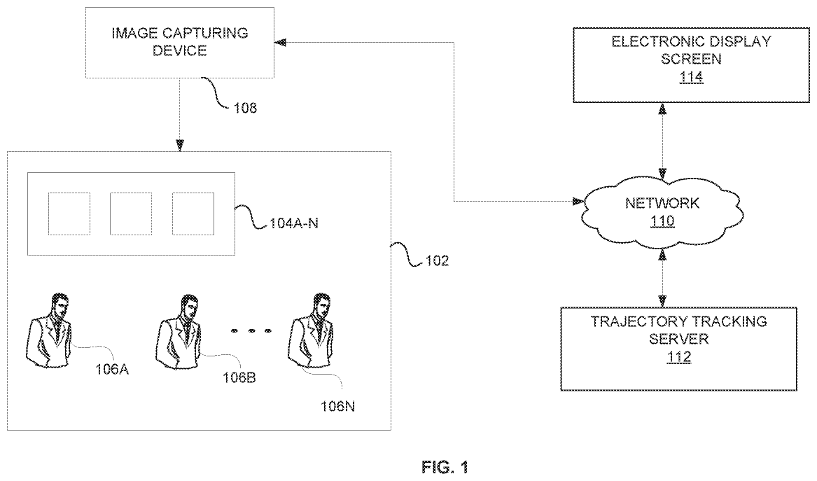

There remains a need to address the aforementioned technical drawbacks using a system and method for determining a trajectory of a ball. Referring now to the drawings, and more particularly to FIGS. 1 to 10, where similar reference characters denote corresponding features consistently throughout the figures, there are shown example embodiments.

In an exemplary embodiment, various modules described herein and illustrated in the figures are embodied as hardware-enabled modules and may be configured as a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that are configured with electronic circuits process computer logic instructions capable of providing at least one digital signals or analog signals for performing various functions as described herein.

FIG. 1 is a schematic illustration of a system 100 for determining a trajectory of a ball. The system 100 includes a global area 102 that includes one or more table tennis (TT) tables 104A-N and one or more players 106A-N. An image capturing device 108 that is associated with the global area 102 to capture a two-dimensional (2D) media-content or a video of the global area 102. A network 110 communicatively connects the image capturing device 108 to a trajectory tracking server 112. The trajectory tracking server 112 is communicatively connected to the image capturing device 108 and an electronic display screen 114. In some embodiments, the network 110 is at least one of a wired network, a wireless network, a combination of the wired network and the wireless network or the Internet. The image capturing device 108 may be a digital camera that may record the 2D media-content at 30 frames per second. In some embodiments, the image capturing device 108 may be a mobile phone, a book reader, a PDA (Personal Digital Assistant), a tablet, a music player, a computer, an electronic notebook, or a smartphone or any other electronic device with image capturing capabilities. The image capturing device 108 captures a 2-dimensional media content of one or more table tennis (TT) tables 104A-N in the global area 102. The global area 102 is the physical area that may be captured from the image capturing device 108 and includes the one or more TT tables 104A-N and the one or more players 106A-N. The trajectory tracking server 112 may obtain the 2D media content of the one or more table tennis (TT) tables 104A-N in the global area 102. The trajectory tracking server 112 localizes a foreground TT game in the 2D media-content using conventional facial recognition techniques of one or more players 106A-N that are associated with the foreground TT game. There may be multiple TT games occurring in the global area 102. The TT games are spaced apart. The foreground TT game is the TT game that is selected for determining the trajectory of the ball while one or more TT games may appear in the background in the 2D media content captured by the imaging capturing device 108 are avoided. The trajectory tracking server 112 eliminates a background of the 2D media-content using three consecutive frames of the 2D media-content to obtain a background-subtracted media-content that identifies moving objects in the foreground TT game. The background may refer to a noise in the 2D media-content that may occur due to another TT game in the media content other than the foreground TT game, or a movement of the one or more players 106A-N in the global area 102. Eliminating the background of the 2D media-content enables the trajectory tracking server 112 to determine the trajectory of the ball in the global area 102 even if there may be a well-contained environment as well as a noisy environment that is observed in table tennis matches and is not affected by other matches in progress in the background or due to movement of the one or more players 106A-N or other people in the global area 102. A well-contained environment may be a region in the global area 102 that may be configured to adapt to the table tennis game and restricted from going beyond a certain limit. A noisy environment may be a region in the global area 102 that may have due to reasons including low contrast or poor lighting conditions or due to movement of people or long horizontal contours due to accidental movement zooming of the image capturing device 108.

The trajectory tracking server 112 locates a plurality of edges of a TT table (e.g., one of TT tables 104A-N) associated with the foreground TT game from the background-subtracted media-content using computer vision methods. Computer vision methods automatically extract and analyze useful information from a single image or a sequence of images associated with the 2D media-content. Computer vision methods are concerned with the automatic extraction, analysis and understanding of useful information from a single image or a sequence of images. Computer vision methods involve development of a theoretical and algorithmic basis to achieve automatic visual understanding. Computer vision methods may include image classification, object detection, object tracking, semantic segmentation or instance segmentation.

The trajectory tracking server 112 determines a pixel-to-metric unit ratio between the 2D media-content and the TT table 104A-N by superimposing the plurality of edges with dimensions of the TT table 104A-N. The pixel-to-metric unit ratio is a ratio between a pixel of the 2D media-content and a metric unit. The trajectory tracking server 112 identifies a contour information of the trajectory of the ball after the ball is serviced using computer vision methods. The contour information includes a contour length, a thickness, endpoints, and a centroid of the trajectory of the ball. The trajectory tracking server 112 determines a speed of the ball in the trajectory using the pixel-to-metric unit ratio and the contour information. The trajectory tracking server 112 transforms the speed that is based on the 2D media-content into a three-dimensional speed. The three-dimensional speed is a real-world speed of the ball in the global area 102. A computer linear or polynomial regression model may be used for transforming the speed of the ball into the three-dimensional speed. The trajectory tracking server 112 may determine the trajectory of the ball in the global area 102 using spline interpolation based on the contour information and the three-dimensional speed of the ball. The ball in the 2D media-content may be tracked based on the trajectory. the trajectory tracking server 112 may output the trajectory on the electronic display screen 114. The trajectory tracking server 112 may use computer-generated mathematical methods, computer vision methods, and a deep learning model, which may include artificial intelligence and machine learning to track the ball from the 2D media content. The trajectory tracking server 112 is configured to determine the trajectory of the ball based on the 2D media-content captured from the image capturing device 108 using computer vision methods and deep neural networking models and hence does not requires a graphics processing unit (GPU), thereby reducing computer system requirements for the trajectory tracking server 112 as GPU is an expensive computational unit. Optionally, the image capturing device 108 may be a general-purpose mobile camera or a closed-circuit television camera. The trajectory tracking server 112 may be able to begin tracking the ball automatically after the ball is serviced.

Optionally, a heatmap of pitch locations may be generated to visually analyze the foreground TT game. The heatmap may indicate the three-dimensional speed of the ball, a placement of the ball into a plurality of zones in the TT table 104A-N, and an indicator that classifies that the placement resulted in a point win or a point loss.

In some embodiments, the trajectory tracking server 112 may utilize face recognition models and human pose models with the trajectory of the ball to track a game of interest in the global area 102 from the 2D media-content of the global area 102. Human pose models are computer models based on computer vision methods that detect and analyze human posture.

In some embodiments, actions of the player in the foreground TT game are classified using a deep learning model that is based on face recognition and human pose models.

In some embodiments, the foreground TT game is localized in the 2D media-content using facial recognition of one or more players 106A-N associated with the foreground TT game. In some embodiments, the method includes generating a top-down view of the pitch locations on the TT table 104A-N by (a) interpolating the plurality of coordinates of the 2D media-content, and (b) generating the top-down view using a perspective transformation.

In some embodiments, the top-down view is combined with the shot-type and the three-dimensional ball speed to enable placement analytics of the player.

In some embodiments, the trajectory of the ball may be used to enable performance analysis of the one or more players 106A-N. The performance analysis may be used to recommend coaching interventions.

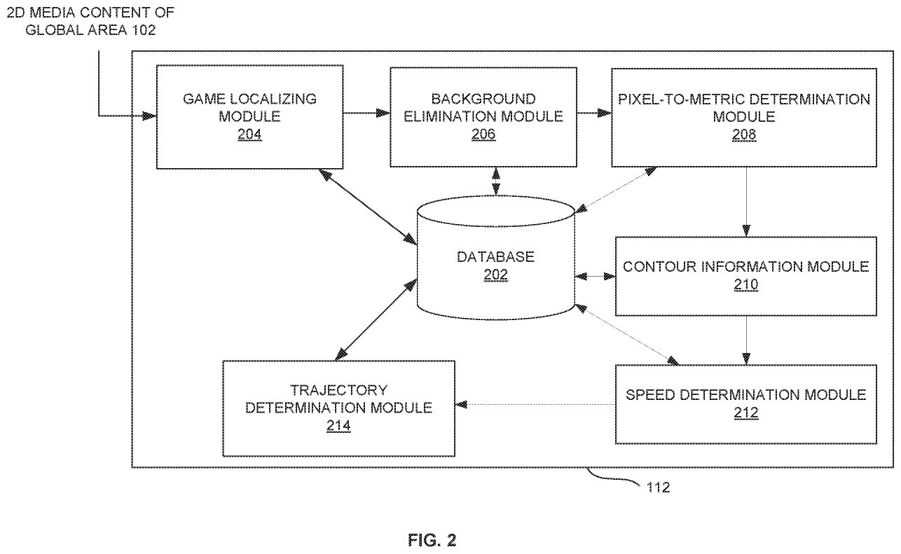

FIG. 2 is an exploded view of the trajectory tracking server 112 of FIG. 1 according to some embodiments herein. The trajectory tracking server 112 includes a database 202, a game localizing module 204, a background elimination module 206, a pixel-to-metric determination module 208, a contour information module 210, a speed determination module 212, and a trajectory determination module 214. The image capturing device 108 captures a two-dimensional media content of one or more table tennis (TT) tables in the global area 102. The game localizing module 204 obtains the 2D media content of the one or more table tennis (TT) tables in the global area 102. The game localizing module 204 localizes a foreground TT game in the 2D media-content using facial recognition of one or more players 106A-N that are associated with the foreground TT game. The background elimination module 206 eliminates a background of the 2D media-content using three consecutive frames of the 2D media-content to obtain a background-subtracted media-content that identifies moving objects in the foreground TT game. A greyscale video frame may be obtained using the three consecutive frames of the 2D media-content in which nearly all non-moving objects are removed. The greyscale video frame may still have the noise due to reasons including low contrast or poor lighting conditions in the global area 102, moving shadows in the global area 102, movement of the one or more players 106A-N or other people in the global area 102, movement of the one or more players 106A-N both in the foreground TT game or match, as well as other background TT games in progress, automatic zooming in or out of the image capturing device 108 while capturing of the 2D media-content is in progress.

To ensure that the correct ball is being tracked and the noise in the 2D media-content is eliminated, an expected breadth (thickness) of a colored streak caused by the ball may be determined by adopting a pixel-to-metric unit ratio. The pixel-to-metric determination module 208 locates a plurality of edges of a TT table 104A-N associated with the foreground TT game from the background-subtracted media-content using computer vision. The pixel-to-metric determination module 208 determines the pixel-to-metric unit ratio between the 2D media-content and the TT table 104A-N by superimposing the plurality of edges with dimensions of the TT table 104A-N. The pixel-to-metric unit ratio may be computed by using computer vision methods to first locate the plurality of edges of the TT table 104A-N. The pixel-to-metric unit ratio may be computed with knowledge of dimensions of the TT table 104A-N in real-time and an apparent length in the greyscale video frame in pixels. In some embodiments, a set of regions and objects of interest in the greyscale video frame are identified. The set of regions and objects of interest that are identified with a presence of small noise, or due to poor lighting or low contrast, or with a presence of large noise, or due to movement of people or long horizontal contours due to accidental movement zooming of the image capturing device 108, is eliminated by computing contours on the grayscale background frame or the background-subtracted media-content.

After the ball is serviced by a player 106A, the ball is immediately localized by performing a global search in the 2D media-content for a colored streak of an expected dimension and locating a region closer to a player associated with servicing the ball. In an embodiment, the ball may be localized after 0.01 seconds of being serviced by the player 106A. In some embodiments, one or more players 106A-N may be present in the background-subtracted media-content. The global search is an action of performing a search for a colored streak of an expected dimension of the ball in the 2D media-content. The one or more players 106A-N may be localized in the background-subtracted media-content using a facial recognition model. For identifying a start of a service in the foreground TT game in the background-subtracted media-content, the global search may be combined with human pose models to ensure that the ball that is associated with the foreground TT game is localized and not some other ball in the 2D media-content.

The contour information module 210 identifies a contour information of the trajectory of the ball after the ball is serviced using computer vision methods. The contour information includes a contour length, a thickness, endpoints, and a centroid of the trajectory. The speed determination module 212 determines a speed of the ball in the trajectory using the pixel-to-metric unit ratio and the contour information. In an embodiment, the speed determination module 212 determines the speed of the ball as shown below:

Speed of the ball in 2-D plane=[the contour length×the pixel-to-metric unit ratio]/frequency of the 2D media-content.

The pixel-to-metric unit ratio is multiplied by the contour length may be determined based on the trajectory of the ball and a value of a frequency of the 2D media-content. The speed is estimated in a 2-D plane.

The speed determination module 212 transforms the speed that is based on the 2D media-content into a three-dimensional speed. A linear or polynomial regression model may be used for transforming the speed of the ball into the three-dimensional speed. The three-dimensional speed is a real-world speed of the ball in the global area 102. In an embodiment, the linear or polynomial regression model may be based on speed radar measurements. An actual speed may be estimated as shown below:

three-dimensional speed=speed of the ball in 2-D plane*regression coefficient+beta

where the regression coefficient and the intercept beta are outputs of the linear regression model.

The trajectory determination module 214 determines the trajectory of the ball in the global area 102 using spline interpolation based on the contour information and the three-dimensional speed of the ball.

One or more parameters associated with the trajectory of the ball may be normalized or modified in some manner to allow for comparisons, such as comparisons between a plurality of game sessions or between the one or more players 106A-N. Some factors that may be considered in a normalization process may include, but are not limited to, ambient conditions, such as wind speed, temperature, and humidity, the physical characteristic of the one or more players 106A-N such as sex, weight, age, and height and a skill level of the one or more players 106A-N.

An expected trajectory of the ball may be determined using spline extrapolation based on the contour information and the three-dimensional speed of the ball. In a period of time when the ball is lost in play or is occluded due to movement of the one or more players 106A-N or people in the global area 102, identification of the contour information may be optimized by obtaining a region of interest (ROI) in the 2D media content based on the expected trajectory to localize the global search, where dimensions of the region of interest are based on the three-dimensional speed of the ball. The ROI is a region in the 2D media-content that enables the trajectory tracking server 112 to localize the global search. If the ball is lost in play or is occluded due to movement of the one or more players 106A-N or people, the global search is re-initiated. In some embodiments, the ROI may be based on the three-dimensional speed of the ball. In some embodiments, a look ahead ROI and the look behind ROI that vary based on the three-dimensional speed and a direction of the ball may be obtained. The look ahead ROI is a region in the 2D media-content where the ball is estimated to go in the trajectory. The look behind ROI is a region in the 2D media-content where the ball is estimated to be returned. Optionally, both the look ahead ROI and the look behind ROI for the ball may be obtained to determine the trajectory of the ball when the ball is being returned. The ROI may have both a directional and a speed-based variation.

Actions of the one or more players 106A-N in the foreground TT game may be classified using the deep learning model. The deep learning model may be based on face recognition and human pose models.

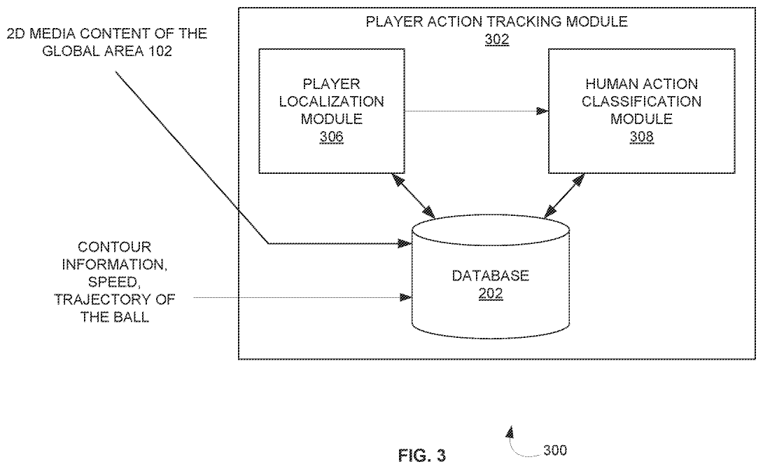

FIG. 3 is a block diagram 300 of tracking actions of the one or more players 106A-N for classifying a shot-type executed by a player 102A in the foreground TT game according to some embodiments herein. The block diagram 300 includes a player action tracking module 302. The player action tracking module 302 includes a database 202, a player localization module 306, and a human action classification module 308. The database 202 obtains the 2D media content of the one or more TT tables 104A-N and the one or more players 106A-N. The database 202 may store the contour information, the speed of the ball, and the trajectory of the ball obtained from the trajectory tracking server 112. The player localization module 306 identifies the one or more players 106A-N using face recognition models and localizes the one or more players 106A-N in a frame of the 2D media-content. A player 106B that is not identified by the player localization module 306 may be marked as “out of frame” and is not localized. For each of the one or more players, 106A-N that are localized in the frame of the 2D media-content, a region of interest (ROI) close to the one or more players 106A-N may be extracted from the 2D media-content to obtain a player localized media content. The human action classification module 308 may classify actions of the player in the foreground TT game using a deep learning model that is based on face recognition and human pose models. In some embodiments, a capsule neural network (not shown) may be used for action recognition. The capsule neural network is a machine learning system that is a type of artificial neural network that can be used to better model hierarchical relationships. The capsule neural network assists in better action recognition as compared to a convolutional neural network. The capsule neural networks are better capable to preserve relative positions of features of the one or more players 106A-N, for example, the relative position of elbow of a player 106A with respect to hip of a player 106A.

In some embodiments, a plurality of key-points on a body of the one or more players 106A-N may be determined using human pose estimation models or a convolutional neural network. The human pose estimation models may provide human pose tracking by using a detector (not shown) that employs detection algorithms that identify, map, and localize human joints, to locate a pose region-of-interest (PROI) within the 2D media-content and employing machine learning (ML) to infer 33 key-points and 2D landmarks of the body from a single frame of the 2D media-content. In an embodiment, the human pose estimation models are run only on a first frame of the 2D media-content. For subsequent frames of the 2D media-content, the PROI may be determined based on the plurality of key-points of the first frame.

The plurality of key-points may be provided as an input to an encoder network (not shown) for creating a latent space from which inputs are fed, into a long short term memory (LSTM) network (not shown) to classify actions of the player in the foreground TT game. LSTM is an artificial recurrent neural network having feedback connections. In an embodiment, a deep learning model combining the encoder network and the LSTM network may be trained on video data associated with the 2D media-content to classify the actions into the following classes including, but not limited to (a) Player(s) idle, (b) Player(s) ready to serve, (c) Service, (d) Backhand shot, and (e) Forehand shot.

Optionally, the backhand shot may be sub-classified into further 8 shot-types by the deep learning model and the forehand shot may be sub-classified into further 8 shot-types by the deep learning model that processes the plurality of frames obtained from an image search of the global area 102 in a dense layer neural network to obtain a learned image transformation and classifying a shot-type or the shot-type information executed by the player by processing the learned image transformations using a recurrent neural network. The player action tracking module 302 may produce the shot-type information as output. The shot-type information may include the speed of the ball determined by the speed determination module 212 and the trajectory of the ball that is determined by the trajectory determination module 214.

In an embodiment, a spin of the ball may also be determined using computer vision and included in the shot-type information. The player action tracking module 302 may be designed or configured to provide feedback and store the shot-type information that may include an impact position height of a shot, a shot velocity or spin velocity as it leaves a racquet associated with the player 106A and a consistency of a shot parameter (such as racquet head speed) and shot results (such as in or out).

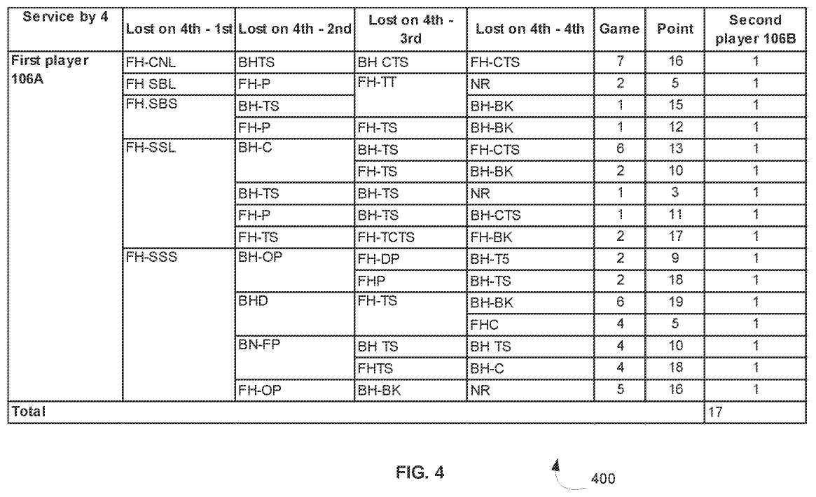

FIG. 4 is an exemplary view of a table 400 of rallies that end at a fourth contact for a player 102A according to some embodiments herein. The table 400 includes the shot-type information for a first player 106A for shots played against a second player 106B. The shot-type information enables placement analytics for the one or more players 106A-N.

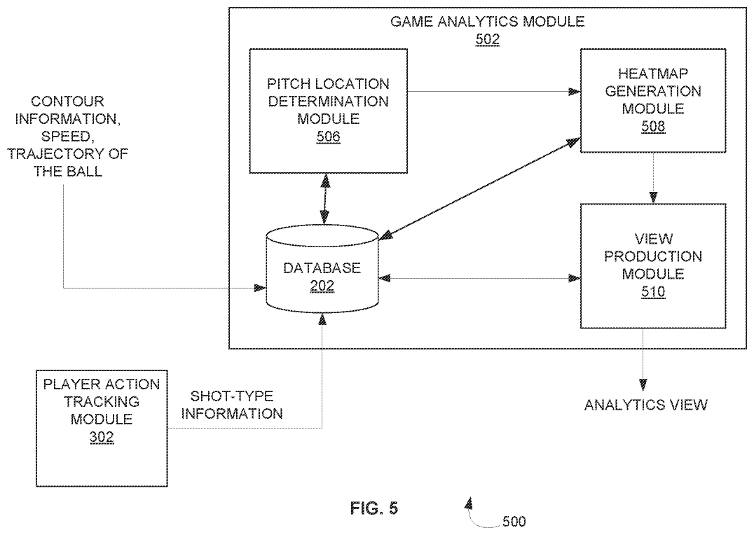

FIG. 5 is a block diagram of a system 500 of placement analytics of the one or more players 106A-N associated with the foreground TT game according to some embodiments herein. The system 500 includes a game analytics module 502. The game analytics module 502 includes the database 202, the pitch location determination module 506, the heatmap generation module 508, and the view production module 510. The database 202 may store shot-type information obtained from the player action tracking module 302. The database 202 may store the contour information, the speed of the ball, and the trajectory of the ball obtained from the trajectory tracking server 112. The shot-type information may include speed of the ball determined by the speed determination module 212 and the trajectory of the ball that is determined by the trajectory determination module 214. The pitch location determination module 506 may compute coordinates in a top-down view of the TT table 104A. Identified locations of the ball based on the contour information that is determined by the contour information module 210 may be fitted to a polynomial curve to obtain a smooth trajectory of the ball. In an embodiment, a precise location of pitching or pitch locations may be identified by computing a tangent to the contours using a point of change in the tangent to the contours.

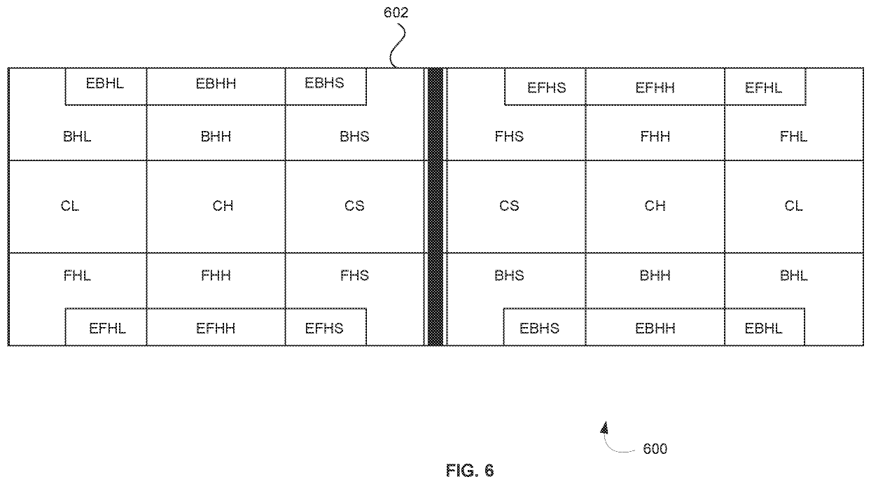

A surface of the TT table 104A where the ball is placed by the one or more players 106A-N may be divided into one or more zones that may be identified through user input such as professional expertise in TT coaching. An illustration of the surface 600 divided into one or more zones is illustrated in FIG. 6. In some embodiments, the one or more zones are 16 and represent a bifurcation of each half of the TT table 104A into a short, a medium, and a long. A placement or pitch location of the ball on the ball on the surface 600 may further be categorized as “backhand” or “forehand”. The heatmap generation module 508 may generate a heatmap of pitch locations to visually analyze the foreground TT game. The heatmap includes the three-dimensional speed of the ball, a placement of the ball into the one or more zones in the TT table 104A-N, and an indicator that classifies that the placement resulted in a point win or a point loss.

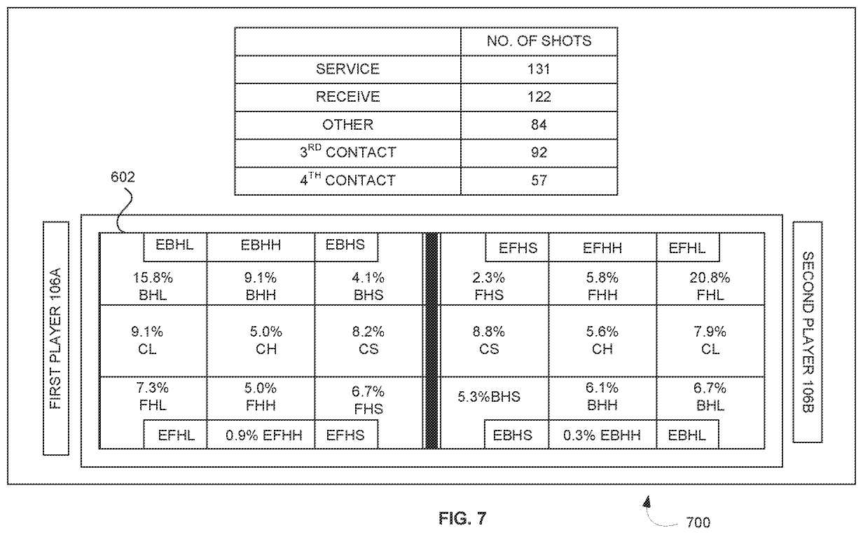

The view production module 510 generates a top-down view of the pitch locations on a TT table 104A-N by interpolating the one or more coordinates of the 2D media-content and generating the top-down view using a perspective transformation. In an embodiment, the precise location of pitching in a sideways view of the TT table 104A-N that may be obtained from the 2D media-content may be converted to a top-down view using perspective transformation. The view production module 510 may combine the top-down view with the shot-type and the three-dimensional ball speed to enable placement analytics of the player. The top-down view may include ball pitch locations as well as a total count of placements in a zone and be represented in each of the plurality of zones. The ball pitch locations and the total count of placements may further be aggregated at a point, a set and a match level of the foreground TT game. Along with the ball pitch locations and the total count of placements, a representation of the placement associated with a shot executed by a player 106C may also include the speed of the ball in the particular and a marker that indicates whether or not the placement resulted in a point win or loss for the player 106C associated with the shot. The representation enables analysis of placement performance of the player 106C and tailoring specific coaching interventions for the player 106C. An exemplary view of placement analytics of the one or more players 106A-N associated with the foreground TT game generated by the system 500 is described in FIG. 7.

The game analytics module 502 enables visually tracking a game of interest in the 2D media content that is captured from the image capturing device 108 using the heatmap of pitch locations. Visually tracking the game of interest enables accurate comprehension of weakness/strength of the one or more players 106A-N associated with the game of interest. For example, a player 106D may be weak in picking up short placements, or weak in responding to long placements as returns due to footwork and not coming into right position.

FIG. 6 is an exemplary view of one or more zones of the surface 600 of the TT table 104A-N that are used to generate the heatmap of pitch locations according to some embodiments herein. The exemplary view of the surface 600 includes a zone view that includes the one or more zones 602 in the TT table 104A-N. The one or more zones 602 may be used to generate the heatmap of pitch locations. The one or more zones 602 are divided to be easily notated, relatable to the TT game, and quick to understand by a user. The one or more zones 602 include extreme backhand long (EBHL), extreme backhand half (EBHH), extreme backhand short (EBHS), extreme front hand short (EFHS), extreme front hand half (EFHH), extreme front hand long (EFHL), backhand long (BHL), backhand half (BHH), backhand short (BHS), front hand short (FHS), front hand half (FHH), front hand long (FHL), center long (CL), center half (CH), center short (CS). Stroke techniques, spins, and actions are together abbreviated for better understanding. For instance, forehand topspin is FH-TS, forehand block is FH-BK, forehand push is FH-P, banana flip is BN-FP, backhand topspin is BH-TS, back hand counter is BH-C, and services as forehand backspin short serve is FH-BSS, backhand sidespin long is BH-SSL, shovel backspin long is SH-BSL, forehand reverse sidespin with backspin short is FH-RSBS, forehand tomahawk short is FH-TMHS. Similarly, the plurality of placement zones are abbreviated as BHS for Backhand Short, BHH for Backhand half, BHL for Backhand long, FHS for Forehand short, CH for Centre half, CL for Center Long, Extreme Forehand Long as EFHL, and so forth. Each side of the table is distributed in 9 major zones and 6 extreme angle zones. The schematic illustration in FIG. 6 describes the 15-placement zones on one side of the table for a right-handed player. For a left-handed player, the forehand and backhand sides may switch.

FIG. 7 is an exemplary view of the first top-down of the pitch locations 700 of the foreground TT game on the TT table 104A-N for enabling placement analytics of the one or more players 106A-N according to some embodiments herein. The first top-down view includes the zone view 602, a first player 106A and a second player 106B. The first top-down view may be visualized on a table tennis table with respective percentage on each of the plurality of zones. One or more interactive buttons may be provided at the top of the dashboard and segregates the ball placements by respective shot numbers like serves, returns, 3^{rd} contact, 4^{th} contact, and others. Upon clicking on any of the plurality of interactive buttons, the placements zone marked with percentage of balls placed by an opponent to the opponent side of the table, along with the information on the type of strokes placed.

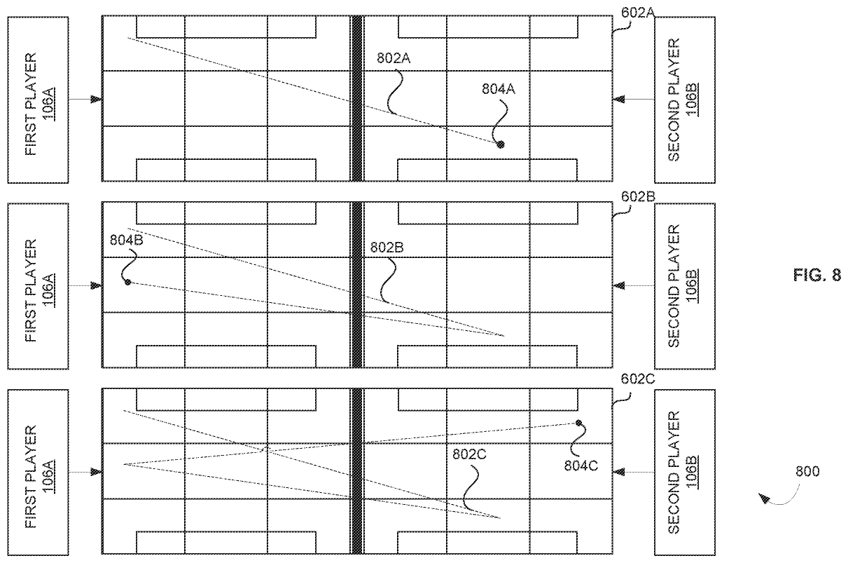

FIG. 8 is an exemplary view of a second top-down view 800 generated based on the trajectory of a rally of the ball according to some embodiments herein. The second top-down view 800 includes the first player 106A, the second player 106B, the plurality of zone views 602A-C, the plurality of trajectories 802A-C, and the plurality of pitch locations 804A-C of a first shot, a second shot, and a third shot. In a first zone view 602A, the first player 106A is shown to place a shot-type “FH-SBL” at zone “FHH”. In a second zone view 602B, the second player 106B is shown to place a shot-type “FH-P” at zone “CH”. In a third zone view, 602C the first player 106C is shown to place a shot-type “FH-TT” at zone “BHL”.

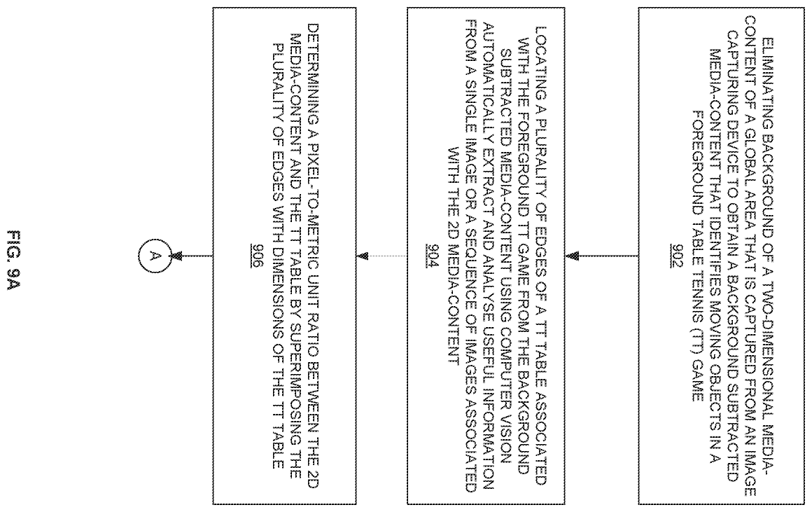

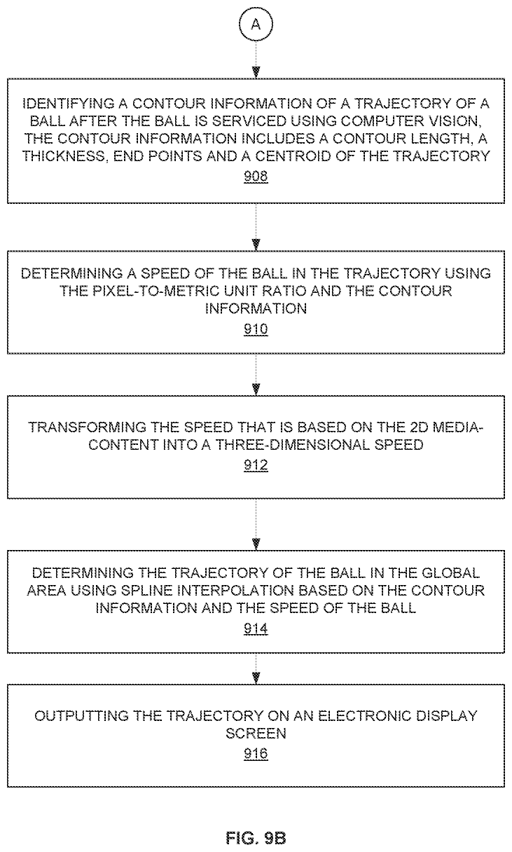

FIGS. 9A and 9B are flow diagrams of a method for determining a trajectory of a ball from a two-dimensional (2D) media-content using computer vision according to some embodiments herein. The 2D media content of at least one TT table 104A-N in the global area 102 is captured by the image capturing device 108. At step 902, the method includes eliminating the background of a two-dimensional (2D) media-content of a global area 102 that is captured from an image capturing device 108 to obtain a background-subtracted media-content that identifies moving objects in a foreground TT game. A computer linear or polynomial regression model is used for transforming the speed of the ball into the three-dimensional speed. The foreground TT game is localized in the 2D media-content using facial recognition of one or more players 106A-N associated with the foreground TT game. Background of the 2D media-content is eliminated using a three consecutive frames of the 2D media-content to obtain a background subtracted media-content that identifies moving objects in the foreground TT game step 904, the method includes locating a plurality of edges of a TT table 104A-N associated with the foreground TT game from the background subtracted media-content using computer vision methods that automatically extract and analyze useful information from a single image or a sequence of images associated with the 2D media-content. At step 906, the method includes determining a pixel-to-metric unit ratio between the 2D media-content and the TT table 104A-N by superimposing the plurality of edges with dimensions of the TT table 104A-N. At step 908, the method includes identifying a contour information of the trajectory of the ball after the ball is serviced using computer vision methods, the contour information includes a contour length, a thickness, end points, and a centroid of the trajectory. At step 910, the method includes determining a speed of the ball in the trajectory using the pixel-to-metric unit ratio and the contour information. At step 912, the method includes transforming the speed that is based on the 2D media-content into a three-dimensional speed. A linear or polynomial regression model may be used for transforming the speed of the ball into the three-dimensional speed. At step 914, the method includes determining the trajectory of the ball in the global area 102 using spline interpolation based on the contour information and the three-dimensional speed of the ball. At step 916, the method includes outputting the trajectory on an electronic display screen 114.

The embodiments herein may include a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules utilized herein include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

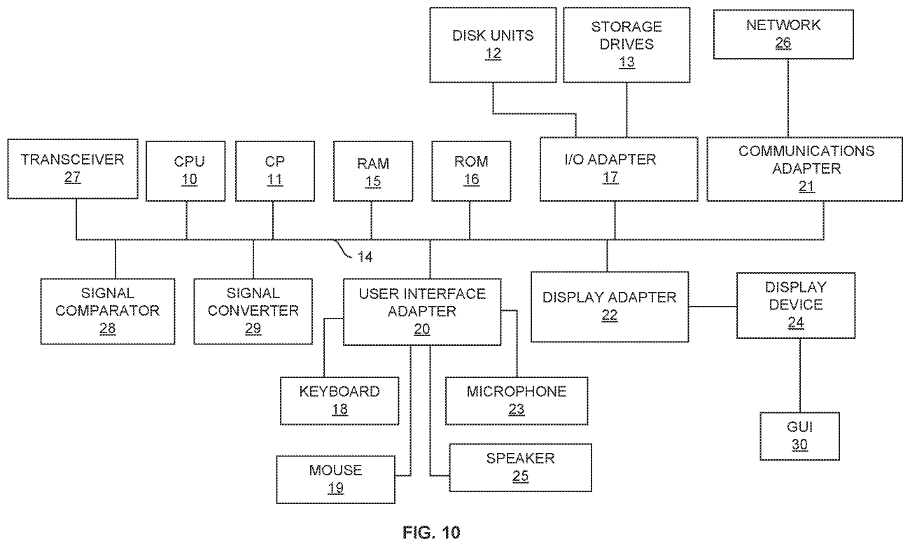

A representative hardware environment for practicing the embodiments herein is depicted in FIG. 10, with reference to FIGS. 1 through 9B. This schematic drawing illustrates a hardware configuration of the trajectory tracking server 112 or a computer system or a computing device in accordance with the embodiments herein. The system includes at least one processing device CPU 10 that may be interconnected via system bus 14 to various devices such as a random-access memory (RAM) 12, read-only memory (ROM) 16, and an input/output (I/O) adapter 18. The I/O adapter 18 can connect to peripheral devices, such as disk units 38 and program storage devices 40 that are readable by the system. The system can read the inventive instructions on the program storage devices 40 and follow these instructions to execute the methodology of the embodiments herein. The system further includes a user interface adapter 22 that connects a keyboard 28, mouse 30, speaker 32, microphone 34, and other user interface devices such as a touch screen device (not shown) to the bus 14 to gather user input. Additionally, a communication adapter 20 connects the bus 14 to a data processing network 42, and a display adapter 24 connects the bus 14 to a display device 26, which provides a graphical user interface (GUI) 36 of the output data in accordance with the embodiments herein, or which may be embodied as an output device such as a monitor, printer, or transmitter, for example.

The system is able to determine the trajectory of the ball based on the 2D media-content captured from the image capturing device 108 without requiring a graphics processing unit (GPU). Optionally, the image capturing device 108 may be a low-end mobile camera as the 2D media-content may be generated from a camera recording from a low-resolution, as the system does not require the image capturing device 108 to be a high-end camera that may capture media content in high definition. Further, a requirement of manual inputs associated with characteristics of the ball are minimized. Accordingly, the system may be able to track the ball automatically.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A computer-implemented method of determining a trajectory of a ball from a two-dimensional (2D) media-content using computer vision, the method comprising:
eliminating a background of the 2D media-content of a global area that is captured from an image capturing device to obtain a background subtracted media-content that identifies moving objects in a foreground table tennis (TT) game appearing in a foreground of the 2D media-content;
locating a plurality of edges of a TT table associated with the foreground TT game from the background subtracted media-content using computer vision methods that automatically extract and analyze useful information from a single image or a sequence of images associated with the 2D media-content;
determining a pixel-to-metric unit ratio between the 2D media-content and the TT table by superimposing the plurality of edges with dimensions of the TT table;
identifying a contour information of the trajectory of the ball after the ball is serviced using computer vision methods, wherein the contour information comprises a contour length, a thickness, end points, and a centroid of the trajectory;
determining a speed of the ball in the trajectory using the pixel-to-metric unit ratio and the contour information;
transforming the speed that is based on the 2D media-content into a three-dimensional speed;
determining the trajectory of the ball in the global area using spline interpolation based on the contour information and the three-dimensional speed of the ball; and outputting the trajectory on an electronic display screen.

2. The computer-implemented method of claim 1, comprising using a linear or polynomial regression model for transforming the speed of the ball into the three-dimensional speed.

3. The computer-implemented method of claim 1, comprising localizing the ball immediately after the ball is serviced by performing a global search in the 2D media-content for a colored streak of an expected dimension and locating a region closer to a player associated with servicing the ball.

4. The computer-implemented method of claim 3, wherein identifying the contour information is optimized by:
determining an expected trajectory of the ball using spline extrapolation based on the contour information and the three-dimensional speed of the ball; and
obtaining a region of interest (ROI) in the 2D media content based on the expected trajectory to localize the global search, wherein dimensions of the region of interest are based on the three-dimensional speed of the ball.

5. The computer-implemented method of claim 3, comprising obtaining a look ahead ROI and a look behind ROI that vary based on the three-dimensional speed and a direction of the ball.

6. The computer-implemented method of claim 1, comprising:
processing a plurality of frames obtained from an image search of the global area in a dense layer neural network to obtain a learned image transformation; and
classifying a shot-type executed by a player by processing the learned image transformation using a recurrent neural network.

7. The computer-implemented method of claim 1, comprising generating a heatmap of pitch locations to visually analyze the foreground TT game, wherein the heatmap comprises the three-dimensional speed of the ball, a placement of the ball into a plurality of zones in the TT table, and an indicator that classifies that the placement resulted in a point win or a point loss.

8. The computer-implemented method of claim 7, comprising generating a top-down view of the pitch locations on the TT table by:
interpolating a plurality of coordinates of the 2D media-content; and
generating the top-down view using a perspective transformation.

9. The computer-implemented method of claims 6 and 8, comprising combining the top-down view with the shot-type and the three-dimensional speed to generate placement analytics of a player.

10. The computer-implemented method of claim 1, comprising classifying actions of a player in the foreground TT game using a deep learning model that is based on face recognition and human pose models.

11. The computer-implemented method of claim 1, comprising localizing the foreground TT game in the 2D media-content using facial recognition of a plurality of players associated with the foreground TT game.

12. A system for determining a trajectory of a ball from a two-dimensional (2D) media content using computer vision, the system comprising:
an electronic display screen that outputs the trajectory;
an image capturing device that captures the 2D media content of at least one table tennis (TT) table in a global area; and
a trajectory tracking system that analyzes a plurality of frames of the 2D media content associated with said at least one TT table in the global area and determines a trajectory of the ball, wherein the trajectory tracking system is communicatively connected to the image capturing device, the trajectory tracking system comprising:
a memory that stores a database and a set of modules; and
a device processor that executes said set of modules, wherein said set of modules comprise:
a background elimination module that eliminates background of the 2D media-content to obtain a background subtracted media-content that identifies moving objects in a foreground TT game;
a pixel-to-metric determination module that locates a plurality of edges of a TT table associated with the foreground TT game from the background subtracted media-content using computer vision methods that automatically extract and analyze useful information from a single image or a sequence of images associated with the 2D media-content and determines a pixel-to-metric unit ratio between the 2D media-content and the TT table by superimposing the plurality of edges with dimensions of the TT table;
a contour information module that identifies a contour information of the trajectory of the ball after the ball is serviced using computer vision methods, wherein the contour information comprises a contour length, a thickness, end points and a centroid of the trajectory;
a speed determination module that determines a speed of the ball in the trajectory using the pixel-to-metric unit ratio and the contour information, and transforms the speed that is based on the 2D media-content into a three-dimensional; and
a trajectory determination module that determines the trajectory of the ball in the global area using spline interpolation based on the contour information and the three-dimensional speed of the ball.

13. A non-transitory computer-readable storage medium storing a sequence of instructions, which when executed by a processor, causes, to perform a method of determining a trajectory of a ball from a two-dimensional (2D) media-content using computer vision, wherein the method comprises:
eliminating a background of the 2D media-content of a global area that is captured from an image capturing device to obtain a background subtracted media-content that identifies moving objects in a foreground table tennis (TT) game appearing in a foreground of the 2D media-content;
locating a plurality of edges of a TT table associated with the foreground TT game from the background subtracted media-content using computer vision methods that automatically extract and analyze useful information from a single image or a sequence of images associated with the 2D media-content;
determining a pixel-to-metric unit ratio between the 2D media-content and the TT table by superimposing the plurality of edges with dimensions of the TT table;
identifying a contour information of the trajectory of the ball after the ball is serviced using computer vision methods, wherein the contour information comprises a contour length, a thickness, end points, and a centroid of the trajectory;
determining a speed of the ball in the trajectory using the pixel-to-metric unit ratio and the contour information;
transforming the speed that is based on the 2D media-content into a three-dimensional speed;
determining the trajectory of the ball in the global area using spline interpolation based on the contour information and the three-dimensional speed of the ball; and
outputting the trajectory on an electronic display screen.
